(19) United States
(12) Patent Application Publication
(10) Pub. No.: US 2004/0220049 A1
(43) Pub. Date: Nov. 4, 2004

(54) Catalyst

(76) Inventors: William Patrick Hems, Norfolk (GB); Graham John Hutchings, North Yorkshire (GB)

Correspondence Address: Christopher R Lewis, RatnerPrestia, One Westlakes Berwyn Suite 301, PO Box 980, Valley Forge, PA, 19482-0980, US

(21) Appl. No.: 10/416,053

(22) PCT Filed: Nov. 1, 2001
(86) PCT No.: PCT/GB01/04842

(30) Foreign Application Priority Data
Nov. 3, 2000 (GB) GB0026890.4

(51) Int. Cl. B01J 31/00; C07F 17/02

(52) U.S. Cl. 502/150; 502/166; 556/22

(57) ABSTRACT

A solid catalyst for asymmetric hydrogenation reactions is disclosed comprising a chiral cationic metal-ligand complex immobilised on a mesoporous alumino-silicate support. The catalyst is formed by ion exchange with the acid sites of the support. The catalyst is reusable, and maintains its activity after use.

The present invention concerns catalysts, especially catalysts which are useful for asymmetric reactions to produce chiral products. More specifically, the invention concerns immobilised chiral catalysts and processes that utilise such catalysts.

Asymmetric catalysis is increasingly important for the preparation of chiral products that are used in speciality applications such as in the manufacture of pharmaceuticals. Suitable catalysts for asymmetric reactions are well known in the art and include compounds containing chiral ligands such as DUPHOS™. Homogeneous catalysts are generally more advanced than their heterogeneous counterparts in this field, but there is considerable interest in the identification of heterogeneous asymmetric catalysts. The use of heterogeneous catalysts has several process advantages in facilitating product recovery, catalyst separation and reuse of the catalysts, which tend to be relatively expensive. In practice, however, the heterogenisation of homogenous catalysts has often led to a loss in catalytic activity and selectivity.

Three approaches in the design of heterogeneous catalysts may be considered. The first of these is the use of chiral support for an achiral metal catalyst. Secondly, the modification of an achiral heterogeneous catalyst using a chiral cofactor, for example nickel metal modified with tartaric acid and sodium bromide, which can be applied to the asymmetric hydrogenation of β-ketoesters and β-diketones; or platinum modified with a cinchona alkaloid which is useful for the enantioselective hydrogenation of α-keto esters and acids (see Blaser et al, Catalysis Today 37 (1997) 441-463). The third approach involves the immobilisation of a homogeneous chiral catalyst. The most common method in the prior art has been to attach a ligand or metal-ligand complex to a solid support material as described for example by Brandts et al in 18^{th} Conference on Catalysis of Organic Reactions Preprints Poster #4 (30 Apr.-4 May 2000). The reference describes tethering both chiral and non-chiral rhodium complexes to γ-alumina using an anchoring agent based on phosphotungstic acid, phosphomolydic acid or silicotungstic acid.

F. de Rege et al (18^{th} Conference on Catalysis of Organic Reactions Preprints Poster #4 (30 Apr.-4 May 2000, J. C. S. Chem. Comm., 2000, 1797 and Chem. Ind. 2001, 82, 439-450) describe an immobilised chiral rhodium complex, [(R,R)-Me-(DuPHOS)—Rh(COD)][OTf ]on silica-MCM-41. The complexes are anchored to the support by hydrogen bonding between the triflate anion of the complex and Si—OH groups on the silica surface. The resulting immobilised catalyst may be recovered from a reaction mixture and reused provided that a non-polar reaction solvent is used to avoid leaching of the active species.

Johnson et al (Chem. Commun. 1999, 1167) describe confining a chiral catalyst within the walls of a silica-MCM-41 by first deactivating the surface sites, then treating the internal walls with 3-bromopropyltrichlorosilane, reaction of the treated support with a precursor of the chiral catalyst, followed by further treatment to produce the final catalyst. The catalyst is thereby covalently linked to the chemically-modified silica support.

Hölderich in DE 19820411 describes hydrogenation catalysts prepared by mixing Al-MCM-41 with either (S,S)-MeDuPHOS and [{Rh(cod)Cl₂}₂] or (R,R)-DIOP and [Rh(acac)(CO)₂1. In both cases the catalysts require long reaction times (at least 24 hours) and provide poor enantioselectivities compared to the homogeneous equivalents.

In order to overcome problems with the prior art systems, it is desirable to anchor a pre-formed homogeneous catalyst to a support, without the need for any ligand modification, or alternatively to anchor a suitable metal precursor to the support and then build the complex on the support by addition of a ligand. EP-A-0831086 describes the application of this technique to the enantioselective aziridination of alkenes using a Cu²⁺— exchanged zeolite Y modified with bis(oxazolines). A similar approach has also been applied to the epoxidation of alkenes using a Manganese-exchanged Al-MCM-41 modified with chiral salen ligand (see Piaggio et al, J. Chem Soc. Perkin Trans 2, 2000, 143).

We have now found that cationic metal-ligand complexes may be immobilised using mesoporous alumino silicates and used to advantage in the asymmetric hydrogenation of prochiral alkenes.

According to the invention we provide a solid catalyst for asymmetric hydrogenabon reactions comprising a chiral cationic metal-ligand complex immobilised on a mesoporous alumino-silicate support.

The chiral cationic metal-ligand complex may be any of those commonly used in the art of asymmetric hydrogenation in homogeneous form. Particularly suitable complexes comprises a cationic metal ion and a neutral mono- or bidentate ligand, which may be represented by the formula [M(L)ₙ]⁺, in which;

M is a metal ion which may be selected from Rh¹⁺, Ir¹⁺ or Ru²⁺,

L is a neutral mono- or bidentate ligand and n is 1 or 2.

In addition to the neutral mono- or bidentate ligand the complex may further comprise at least one further stabilising ligand such as a diene, alkene, carbonyl or aryl group. 1,5-cyclooctadiene (cod) is the most preferred stabilising ligand for these systems.

The neutral mono- or bidentate ligands are selected from those containing P, N, O or S— donor atoms. Preferably, the ligands are bidentate and provide two donor atoms. Such ligands may be abbreviated to P—P, P—N, N—N, O—N and the like. Preferably the neutral ligands contain P donor atoms and most preferably the ligands are bidentate and chiral. Examples of suitable bidentate ligands are as follows:

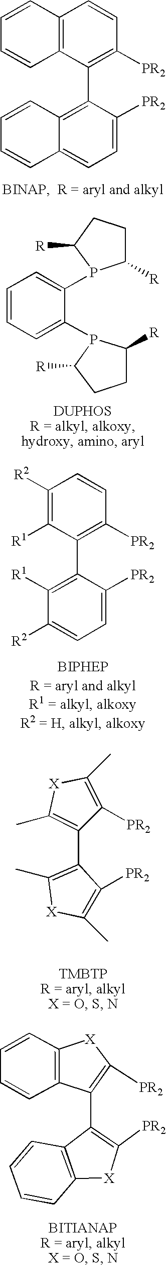

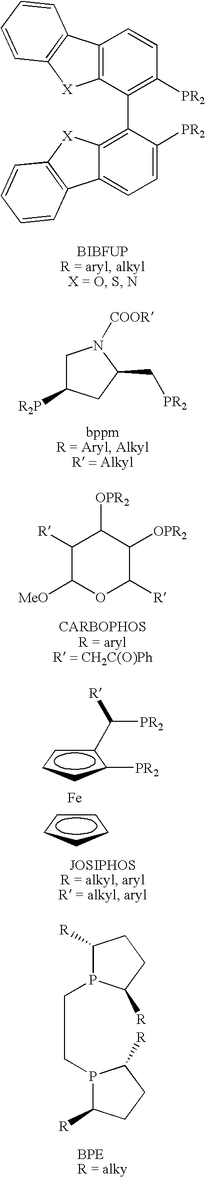

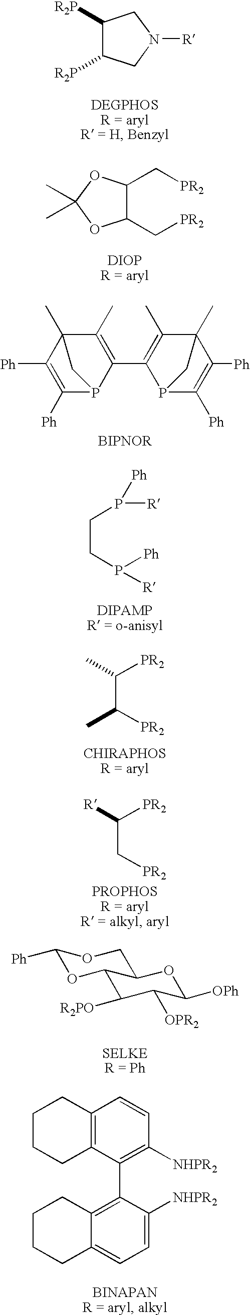

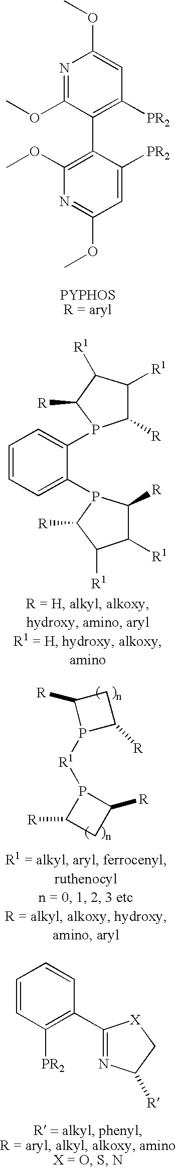

Preferred chiral cationic metal-ligand complexes are rhodium(I) complexes of (R)—BINAP, (R)—PROPHOS, (R,R)-MeDuPHOS and (R,S)-JOSIPHOS and a particularly preferred complexes comprises [(R,R)-MeDuPHOS-Rh(I)(1,5-cyclooctadiene)]⁺ and [(R,S)-JOSIPHOS)Rh(I)(1,5-cyclooctadiene)]⁺.

The invention further provides a method of forming a solid catalyst comprising a chiral cationic metal-ligand complex immobilised on a mesoporous alumino-silicate support, comprising the steps of;

a) forming a solution of a metal-ligand complex [M(L)ₙ]⁺[X]⁻ where X is Cl, BF₄, OTf, or another suitable counter-ion in a polar solvent,

b) stirring together said solution with a solid support comprising a mesoporous aluminosilicate,

c) filtering the resulting solid from the supernatant liquor, and

d) washing the catalyst with solvent,

and a method of forming a solid catalyst comprising a chiral cationic metal-ligand complex immobilised on a mesoporous alumino-silicate support, comprising the steps of;

a) forming a solution of a cationic metal precursor in a polar solvent,

b) stirring together said solution with a solid support comprising a mesoporous aluminosilicate,

c) filtering the resulting solid from the supernatant liquor,

d) stirring together said solid with a solution of a neutral ligand in a solvent, and

e) filtering the resulting solid from the supernatant liquor.

The immobilised catalysts are formed by ion-exchange between a cationic metal-ligand complex and the acidic protons of the mesoporous alumino silicate. The mesoporous alumino-silicate support is preferably a mesoporous silicate material having acidic sites which are suitable for ion exchange [(H⁺)-alumino-silicate]. The presence of the aluminium provides acidic sites for ion exchange with the cationic metal-ligand complex. The Al content of the aluminosilicate is preferably selected to give a ratio of Si to Al of at least 4 and is preferably in the range 5-500:1 by weight. Preferred supports include SBA-15 and Al-MCM-41. SBA-15 is a hexagonal mesoporous silica with uniform pore size up to about 300 angstroms and is described by Zhao et al in Science, 1998 (279), 548-552 and J. Am. Chem. Soc. 1998, 120, 6024-6036. Al-MCM-41 is well known in the art and refers to an alumino-silicate known as the Mobil Composition of Matter described, for example, in WO-91/11390.

The ion exchange of the metal complex may be achieved in at least two different ways. In one method, a solution of a metal-ligand complex [M(L)ₙ]⁺[X]⁻ (where X is Cl, BF₄, OTf, or another suitable counter-ion) is stirred with the solid (H⁺)-alumino-silicate with heating if required, followed by filtration and washing of the exchanged supported catalyst. The solvent is preferably a polar solvent, e.g. an alcoholic solvent such as methanol, ethanol or isopropanol. We have found that the use of a less-polar, non-protic solvent, e.g. dichloromethane, may result in incomplete exchange of the metal complex onto the support.

This preparation method may be illustrated by the example of the direct immobilisation of [Rh(R,R-Me-DuPHOS)(cod)][BF₄], where cod is 1,5-cyclooctadiene, on Al-MCM-41 as follows:

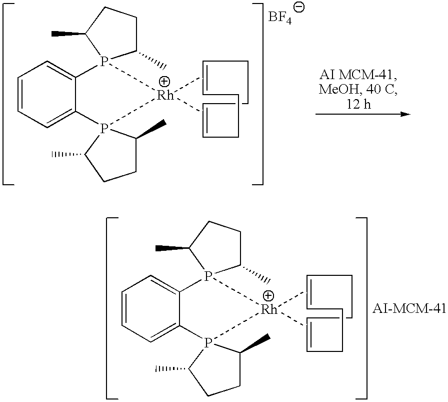

In a second method the supported catalyst is formed by first anchoring a cationic metal precursor onto the support by exchange with acid protons on the support and then adding the ligand to form the immobilised metal-ligand complex of the invention. A preferred example of a suitable cationic metal precursor is [Rh(cod)₂][BF₄]. The first step is simply achieved by stirring a solution of the cationic metal precursor (again preferably in a polar protic solvent such as methanol) with the support. The resulting immobilised cationic metal precursor may if desired be isolated before being treated with the ligand in a suitable solvent, e.g. methanol, acetone, tetrahydrofuran or dichloromethane to form the immobilised metal-ligand complex of the invention. An example of this method for the preparation of a [Rh(R,R)-Me-DuPHOS(cod)]Al-MCM supported catalyst is illustrated below.

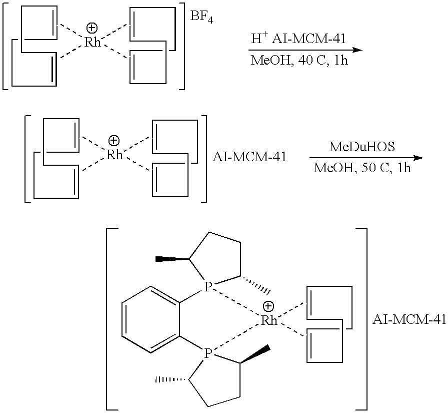

This latter method may be preferable where the chiral ligand has a bulky structure that may reduce the ability of the cationic metal-ligand complex to enter the mesopores of the aluminosilicate support.

The invention further provides a process for performing a hydrogenation reaction comprising contacting a solution of the compound to be hydrogenated with hydrogen at elevated pressure in the presence of a solid catalyst comprising a chiral cationic metal-ligand complex immobilised upon a mesoporous alumino-silicate.

The solid catalysts of the present invention may be used for hydrogenation reactions. Preferred hydrogenation reactions are the hydrogenation of prochiral alkenes, chiral alkenes, ketones, imines and ketimines containing carbon-carbon double bonds and in particular the hydrogenation of succinate, itaconate, methacrylate and acrylate esters, β-ketoesters, enol-acetates and enamides.

The reaction conditions for the hydrogenation reactions may be those well known to those skilled in the art but typically may be at temperatures in the range −10° C.-100° C. and preferably 0-60° C., and at elevated hydrogen pressures in the range of 1 to 100 bar and preferably 3 to 30 bar. Pure hydrogen or hydrogen diluted with an inert gas may be used for the reactions. The amount of catalyst added to the reactions will depend upon the reaction conditions as well as the reactivity of the substrate (i.e. compound to be hydrogenated). Typically substrate : catalyst (metal) molar ratios of 100-5000:1 may be used in the present invention.

The invention is further illustrated by the following examples.

### EXAMPLE 1

### The Preparation of MCM-41 Type Mesoporous Aluminosilicates Al-MCM-41 Type (Si:Al=10:1)

A mixture consisting of tetramethylammonium hydroxide (101.21 g), cetyltrimethylammonium bromide (118.45 g), aluminium isopropoxide (26.56 g) and de-ionised water (860 ml) was stirred at 35° C. for one hour. After this time fumed silica (78.0 g) was added and the resultant mixture was allowed to stir at room temperature for one hour. The gel was then transferred to an autoclave, purged with nitrogen gas (202.6 kPa) and allowed to heat to 150° C. at 30° C. per minute with slow stirring. The autoclave remained at the elevated temperature for a total of 48 hours. The contents of the autoclave were then cooled to ambient temperature (ca 20° C.), filtered and washed with de-ionised water (1 litre) and ethanol (500 ml). The white solid was then oven-dried overnight (110° C. for 16 hours) before being calcined under nitrogen at 550° C. for 16 hours (ramp rate=3° C. per minute). After this, the solid was calcined for four hours in static air at 550° C.

### EXAMPLE 2

### The Preparation of SBA-15 Type Mesoporous Aluminosilicates (Si:Al 8:1)

Tetraethylorthosilicate (27 g) was mixed with aluminium isopropoxide (3.9 g) and aqueous hydrochloric acid (30 ml at pH=1.5). This solution was stirred for three hours and then added to a second solution containing 12 g poly(ethylene glycol)-po/y(propylene glycol)-poly(ethylene glycol) tri-block co-polymer with an average molecular weight of 5800 in aqueous hydrochloric acid (450 ml at pH=1.5). The resultant mixture was stirred for one hour, charged to an autoclave and heated under nitrogen (202.6 kPa) with stirring to 100° C. at 3° C. per minute. The autoclave was held at this elevated spectrum for a total of 64 hours. The solid obtained was filtered, dried at 100° C. overnight and calcined by heating in static air to 550° C. at 25° C. per hour and holding at the elevated temperature for 4 hours.

### EXAMPLE 3

### Preparation of [Rh—(R,R-MeDuPHOS)(cod)]Al-MCM-41 by Direct Ion-Exchange

A mixture of the solid support (H⁺) Al-MCM-41, made in Example 1 (0.2 g) and [Rh—(R,R-MeDuPHOS)(cod)][BF₄] (0.020 g) in degassed methanol (5 ml) was heated at 55° C. for 1 hour during which time the solution became colourless and the solid took on a orange colour. The mixture was filtered and the yellow-orange solid washed with methanol (2×5 ml) and dried under vacuum. The yellow solid was stored under nitrogen.

### EXAMPLE 4A

### Preparation of [Rh(cod)₂]Al-MCM-41

A mixture of the solid support (H⁺) Al-MCM-41 (Si:AI 10:1) (0.2 g) and [Rh(cod)₂][BF₄] (0.020 g, 0.05 mmol) in degassed methanol (5 ml) was stirred at 50° C. overnight under a nitrogen atmosphere. The solid material took on a pale orange colour. The following day the liquid was decanted and a further portion of methanol added. The mixture was filtered and the solid dried under vacuum.

### EXAMPLE 4B

### Preparation of [Rh—(R,R-MeDuPHOS)(cod)]Al-MCM-41

A mixture of [Rh(cod)₂]Al-MCM-41 (0.176 mg) as prepared in Example 4A and (R,R)-MeDUPHOS (16 mg, 0.05 mmol) in degassed methanol (5 ml) was stirred at 50° C. for 1.5 hours. The solid material changed from a pale orange solid to a yellow colour, whilst the methanol solution also became a pale yellow colour. The mixture was cooled to room temperature (ca 20° C.) and then filtered. The yellow solid was then washed thoroughly with methanol and dried under vacuum.

### EXAMPLE 5

### Hydrogenation of Dimethyl Itaconate

Dimethyl itaconate (about 1 mmol) and catalyst were weighed into a glass-liner that was placed inside a 50 ml autoclave to give a substrate:catalyst (Rh) molar ratio of 1000:1. The autoclave was sealed and flushed with nitrogen. The autoclave was then pressurised with hydrogen to 80 psi (506.6 kPa) and then released (cycle repeated 5 times). Sufficient methanol was added to the autoclave to give an approximately 1 M solution of substrate and the 5 cycles of pressurising-releasing with hydrogen were repeated. Finally the autoclave was pressurised with H₂ to 80 psi (506.6 kPa), sealed and left to stir. After the desired time the stirring was stopped and the H₂ released slowly. The autoclave was flushed with nitrogen and the liquid phase removed by syringe through a valve (SWAGELOK™) opening. The products were analysed by chiral gas chromatography using a LIPODEX-E™ column. The conversion after 1 hour and the enantiomeric excess (ee) are shown in Table 1 for different [Rh(Ligand)(cod)]Al-MCM-41 (cod=1,5-cyclooctadiene) complexes immobilised using the method of Example 3.

TABLE 1

| Ligand | Conversion (%) | ee (%) |
|---|---|---|
| (R)-BINAP | 82 | 43 |
| (R)-PROPHOS | 34 | 31 |
| (R,R)MeDUPHOS | 99 | 98 |

### EXAMPLE 6

### Re-Use of Supported Catalyst

The hydrogenation procedure of Example 5 was repeated using the catalyst [Rh(R,R-Me-DuPHOS)(cod)]Al-MCM-41 immobilised according to the method of Example 3 at a substrate:catalyst (Rh) molar ratio of 250:1. After 1 hour (unless otherwise stated) the solid was allowed to settle and the liquid phase was removed by syringe under a positive flow of nitrogen. A fresh aliquot of substrate in methanol (at the same substrate: catalyst ratio) was then added to the autoclave which was re-pressurised with H₂. Conversion and enatiomeric excess (ee) were determined as after each run. The results are shown in Table 2.

TABLE 2

| Run | Conversion (%) | ee (%) |
|---|---|---|
| 1 | >99 | >99 |
| 2 | >99 | >99 |
| 3 | >99 | >99 |
| 4 | >99 | >99 |
| 5 | 99 | 98 |
| 6 | 98 | 96 |
| 7 | 95 | 95 |
| 8 | 99 | 95 |
| 9 (overnight) | 93 | 94 |

The results show that the solid supported catalyst may be successfully reused many times whilst maintaining its catalytic activity.

### EXAMPLE 7

### Comparison with Homogeneous Catalyst

The hydrogenation of dimethyl itaconate was performed using the general procedure of Example 5 in methanol (1 M) at 20° C. with a substrate: catalyst (Rh) molar ratio of 5000:1 and at 506.5 kPa H₂ the immobilised catalyst [Rh(R,R-MeDuPHOS)(cod)]Al-MCM-41 (cod=1.5-cyclooctadiene), prepared according to Examples 4A/4B (i.e. via the cationic precursor complex [Rh(cod)₂][BF₄]). After the time shown in Table 3, the solid was allowed to settle and the liquid phase was removed by syringe under a positive flow of nitrogen. A fresh aliquot of substrate (at the same substrate: catalyst ratio) in methanol was then added to the autoclave, which was re-pressurised with H₂. Conversion and enantiomeric excess (ee) were determined as before after each run.

As a comparison, the reaction was performed in methanol (1 M) at 20° C., with a substrate: catalyst ratio of 5000:1 and at 506.6 kPa H₂ using the unsupported homogeneous catalyst [Rh(R,R-MeDuPHOS)(cod)][BF₄] following the general procedure of Example 5. The results are shown in Table 3.

TABLE 3

| Run | Time (h) | Conversion (%) | ee (%) |
|---|---|---|---|
| 1 | 1 | >99 | 96 |
| 2 | 2.5 | 98 | 97 |
| 3 | 12 | 97.5 | 94 |
| Homogeneous | 1 | >99 | 94 |
| catalyst | | | |
| (comparison) | | | |

The results demonstrate that even at high substrate:catalyst ratios, the supported catalyst produces results which are at least comparable to the corresponding homogeneous metal ligand catalyst complex.

### EXAMPLE 8

### Hydrogenation of Dimethyl Itaconate Using SBA-Type Supported Ligands

Two [Rh—(R,R)-MeDuPHOS(cod)]SBA-15 catalysts were prepared using the general methods described in Examples 3 and 4A/4B, using the (H⁺)-SBA-15 prepared in Example 2, and either [Rh—(R,R)-MeDuPHOS(cod)][BF₄] or [Rh(cod)₂][BF₄] and (R,R)-MeDuPHOS respectively. The catalysts were tested in the hydrogenation of dimethyl itaconate according to the general method of Example 5 (with a substrate: catalyst (Rh) molar ratio=1000:1). Conversion of the substrate was complete after 15 minutes giving a product having in each case, an enantiomeric excess of 98%.

### EXAMPLE 9

### Hydrogenation of Methyl-2-acetamidoacrylate Using SBA-Type Supported Ligands

A Rh—(R,R)-MeDuPHOS(cod)]SBA-15 catalyst prepared according to the method of Example 3 was used for the hydrogenation of methyl-2-acetamidoacrylate (MAA) according to the general method of example 5 (using about 1 mmol MAA and a substrate: catalyst (Rh) molar ratio=1000:1) and then re-used several times at the same substrate: catalyst ratio according to the basic method as used in Example 6. The reaction scheme and results are shown below and in Table 4.

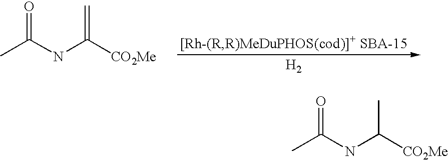

TABLE 4

| Run | Time to full conversion | ee (%) |
|---|---|---|
| 1 | 10 | 95 |
| 2 | 10 | 99 |
| 3 | 10 | 97 |
| 4 | 15 | 97 |
| 5 | 20 | 92 |
| 6 | 30 | 80 |
| 7 | 45 | 79 |

The results show that the catalysts can be isolated and re-used many times whilst maintaining high activity.

### EXAMPLE 10A

### Preparation of [Rh(cod)2]Al-MCM-41 having a Higher Si:Al ratio.

A mixture of a lower Al-containing solid support H⁺ Al-MCM-41 (Si:Al=73:1) (0.73 g) and [Rh(cod)₂][BF₄] (0.010 g, 0.024 mmol) in degassed methanol (10 ml) was stirred at 40° C. for 1 hour under a nitrogen atmosphere. The solid material took on a pale orange colour. The liquid was decanted and a further portion of methanol added. The mixture was filtered and the solid dried under vacuum.

### EXAMPLE 10B

### Preparation of[Rh—(R,S-JOSIPHOS)(cod)]Al-MCM-41

The [Rh(cod)₂]Al-MCM-41 (0.7 g) as prepared in Example 10A and (R,S)-JOSIPHOS (15.3 mg, 0.024 mmol) in degassed methanol (10 ml) was stirred at 50° C. for 1 hour. The solid material changed from a pale orange solid to a yellow colour, whilst the methanol solution also became a pale yellow colour. The mixture was cooled to RT and then filtered. The yellow solid was then washed thoroughly with methanol and dried under vacuum. The preparation of the catalyst is depicted below.

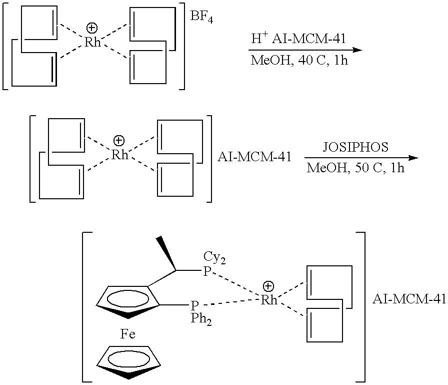

### EXAMPLE 11

### Hydrogenation Reaction Using [Rh—(R,S-JOSIPHOS)(cod)]Al-MCM-41

Dimethyl itaconate was hydrogenated following the general method described in Example 5 using a substrate:catalyst (Rh) molar ratio of 500:1, but allowing only 15 minutes reaction time. The catalyst was allowed to settle and the supernatant containing the product removed by syringe. The catalyst was then reused (at the same substrate: catalyst ratio) according to the method of Example 6. The results are given in Table 5.

TABLE 5

| Run | Conversion (%) | ee (%) |
|---|---|---|
| 1 | 99 | 94 |
| 2 | 99 | 92 |
| 3 | 99 | 92 |
| 4 | 99 | 92 |
| 5 | 99 | 91 |
| 6 | 98 | 91 |
| 7 | 98 | 91 |
| 8 | 99 | 92 |
| 9 | 98 | 91 |
| 10 | 98 | 90 |

The results show that the JOSIPHOS catalyst may be successfully immobilised on a mesoporous support having a higher Si:AI ratio and that the resulting catalyst is active and selective, and may be recycled without significant reduction in activity or selectivity.

1. A method of forming a solid catalyst comprising a chiral cationic metal-ligand complex immobilised on a mesoporous alumino-silicate support, wherein the method comprises the steps of:
a) forming a solution of [Rh(cod)₂][BF₄] in a polar solvent,
b) stirring together said solution with a solid support comprising a mesoporous aluminosilicate having acidic sites which are suitable for ion exchange,
c) filtering the resulting solid from the supernatant liquor of step b),
d) stirring together said solid with a solution of a neutral ligand selected from the group consisting of (R)—BINAP, (R)—PROPHOS, (R,R)-MeDuPHOS and (R,S)-JOSIPHOS, in a solvent, and
e) filtering the resulting solid from the supernatant liquor of step d).

2. A method according to claim 1 wherein the solvent is methanol.

3. A method according to claim 1 wherein the support has a Si to Al ratio in the range 5-500:1 by weight.

4. A method according to claim 1 wherein the support is SBA-15 or Al-MCM-41.
